(19) United States
(12) Patent Application Publication
(10) Pub. No.: US 2025/0358672 A1
(43) Pub. Date: Nov. 20, 2025

(54) METHODS, DEVICES, AND SYSTEMS FOR DELIVERING QOS FLOW INFORMATION

(71) Applicant: ZTE Corporation, Shenzhen (CN)

(72) Inventors: Yingjun ZHOU, Shenzhen (CN); Dapeng Li, Shenzhen (CN); Xiubin Sha, Shenzhen (CN); Zhuang Liu, Shenzhen (CN); Yin Gao, Shenzhen (CN)

(73) Assignee: ZTE Corporation, Shenzhen (CN)

(21) Appl. No.: 19/291,901

(22) Filed: Aug. 6, 2025

Related U.S. Application Data
(63) Continuation of application No. PCT/CN2023/095308, filed on May 19, 2023.

(51) Int. Cl. H04W 28/02; H04W 76/10; H04W 76/20

(52) U.S. Cl. CPC H04W 28/0268; H04W 76/10; H04W 76/20

(57) ABSTRACT

The present disclosure describes methods, system, and devices for delivering quality of service (QoS) flow information. The method includes sending, by a first network node, a first message via a communication interface to a second network node, the first message comprising a list of parameters corresponding to a data burst comprising at least one protocol data unit (PDU) set; and receiving, by the first network node, a second message via the communication interface from the second network node, the second message being responsive to the first message.

### TECHNICAL FIELD

The present disclosure is directed generally to wireless communications. Particularly, the present disclosure relates to methods, devices, and systems for delivering quality of service (QoS) flow information.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Some devices and applications require high date rate and low latency, for example, applications including Extended Reality (XR), virtual reality (VR), Mixed Reality (MR), video streaming, etc. Efficient and robust congestion control and mitigation mechanism is critical for supporting these applications. Identification and awareness of data packets that are dropped may be utilized by a receiving entity, so the receiving entity may be aware of these data packets dropped as early as possible. In some applications, deliver the delivering quality of service (QoS) flow information is used to support XR services. As these kinds of service requires high data rate and low latency, the QoS flow information is used to optimize gNB radio resource scheduling, e.g. improving scheduling efficiency. When the scheduling is improved, the data rate and latency can be ensured. There are many issues/problems associated with informing QoS flow information among wireless communication nodes and/or between wireless communication nodes and wireless communication devices. The issues/problems may include and result in long latency, more signalling overhead, and/or long interruption time.

The present disclosure describes various embodiments for delivering quality of service (QoS) flow information, addressing at least one of the issues/problems discussed above. Various embodiments in the present disclosure may achieve low latency, low overhead, and short interruption time, thus, improving the efficiency and/or performance of the wireless communication.

### SUMMARY

This document relates to methods, systems, and devices for wireless communication, and more specifically, for delivering quality of service (QoS) flow information. Various embodiments in the present disclosure may increase the resource utilization efficiency, boost latency performance of the wireless communication, and/or conserve energy consumption of user equipment.

In one embodiment, the present disclosure describes a method for wireless communication. The method includes sending, by a first network node, a first message via a communication interface to a second network node, the first message comprising a list of parameters corresponding to a data burst comprising at least one protocol data unit (PDU) set; and receiving, by the first network node, a second message via the communication interface from the second network node, the second message being responsive to the first message.

In another embodiment, the present disclosure describes a method for wireless communication. The method includes receiving, by a second network node, a first message via a communication interface from a first network node, the first message comprising a list of parameters corresponding to a data burst comprising at least one PDU set; and sending, by the second network node, a second message via the communication interface to the first network node, the second message being responsive to the first message.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may include a non-transitory computer-readable medium.

The above and other aspects and their implementations are described in greater detail in the drawings, the descriptions, and the claims.

### BRIEF DESCRIPTION OF THE DRAWINGS

FIG. 1A shows a schematic diagram of a wireless communication system.

FIG. 1B shows a schematic diagram of a base station.

FIG. 1C shows another schematic diagram of a base station.

FIG. 1D shows a schematic diagram of application data unit structure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a flow diagram of an exemplary embodiment for wireless communication.

FIG. 6 shows a flow diagram of another exemplary embodiment for wireless communication.

FIG. 7 shows a flow diagram of another exemplary embodiment for wireless communication.

FIG. 8 shows a flow diagram of another exemplary embodiment for wireless communication.

FIG. 9 shows a flow diagram of another exemplary embodiment for wireless communication.

FIG. 10 shows a flow diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context.

In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for delivering quality of service (QoS) flow information.

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Some devices and applications require high date rate and low latency, for example, applications including Extended Reality (XR), virtual reality (VR), Mixed Reality (MR), video streaming, etc. Efficient and robust congestion control and mitigation mechanism is critical for supporting these applications. Identification and awareness of data packets that are dropped may be utilized by a receiving entity, so the receiving entity may be aware of these data packets dropped as early as possible. In some applications, deliver the delivering quality of service (QoS) flow information is used to support XR services. As these kinds of service requires high data rate and low latency, the QoS flow information is used to optimize gNB radio resource scheduling, e.g. improving scheduling efficiency. When the scheduling is improved, the data rate and latency can be ensured. There are many issues/problems associated with informing flow information among wireless communication nodes and/or between wireless communication nodes and wireless communication devices. The issues/problems may include and result in long latency, more signalling overhead, and/or long interruption time.

In various embodiments, methods may include delivering QoS flow information via various interface, for example, NG interface, F1 interface, E1 interface, and/or Xn interface. The QoS flow information may include the uplink (UL) and downlink (DL) traffic periodicity, UL and DL traffic jitter information (e.g. jitter range), burst arrival time, protocol data unit (PDU) set QoS parameters. In some implementations, the PDU set QoS parameter may include the PDU set error rate, PDU set delay budget, PDU set integrated handling indication. The QoS flow information is used to optimize gNB radio resource scheduling, achieving high efficiency of wireless communication. This can also be used for QoS flow to DRB mapping.

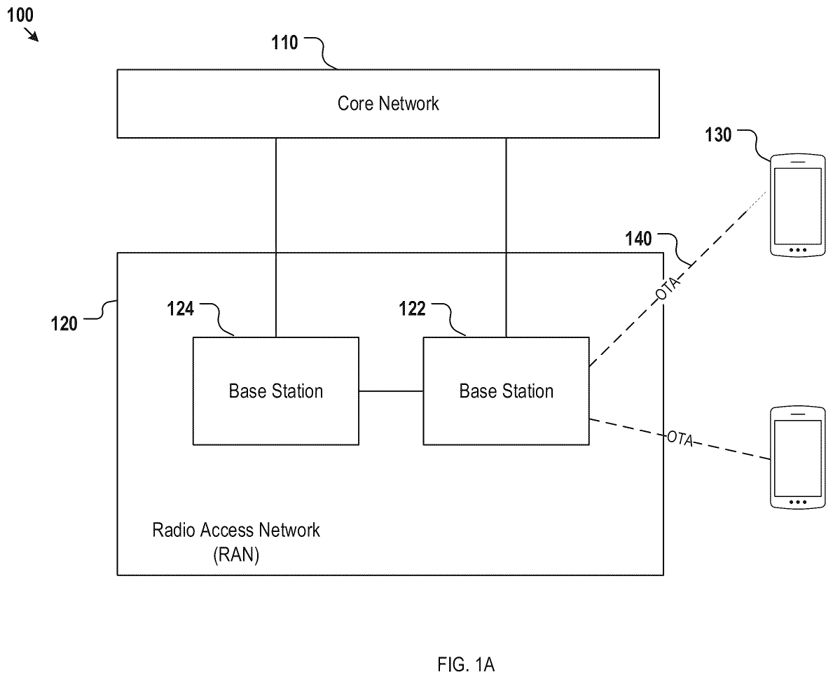

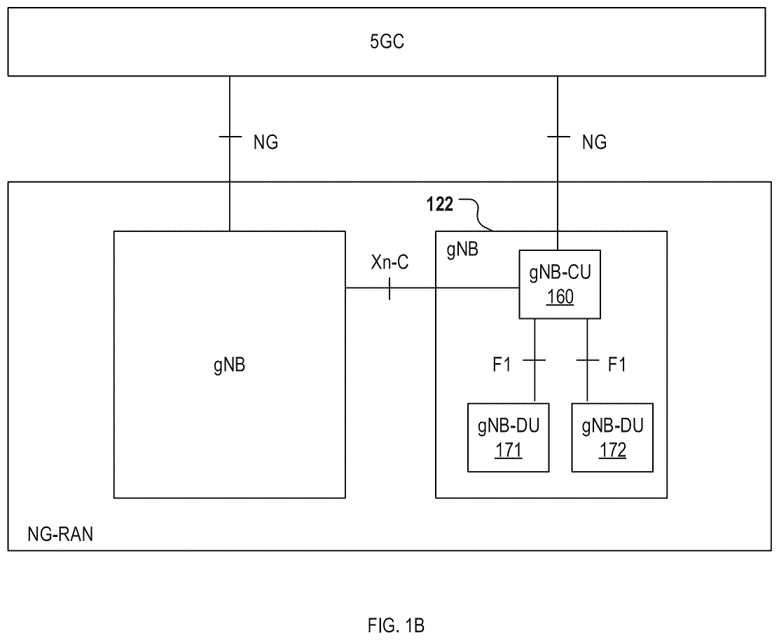

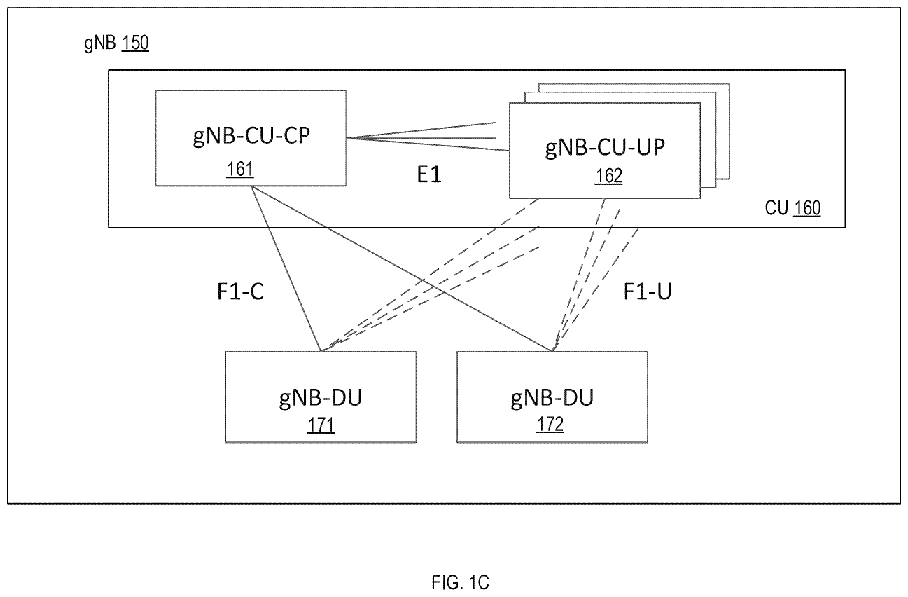

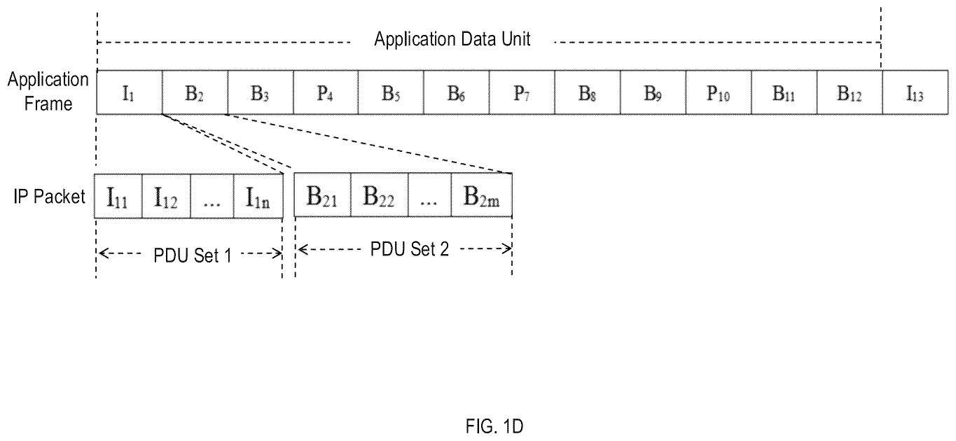

FIG. 1A shows an example cellular wireless communication network 100 (also referred to as wireless communication system) that includes a core network 110, a radio access network (RAN) 120, and one or more user equipment (UE) 130.

The RAN 120 further includes multiple base stations 122 and 124. The base station 122 and one or more user equipment (UE) 130 communicate with one another via over the air (OTA) radio communication resources 140. The wireless communication network 100 may be implemented as, for example, a 2G, 3G, 4G/LTE, 5G, or 6G cellular communication network. Correspondingly, the base stations 122 and 124 may be implemented as a 2G base station, a 3G nodeB, an LTE eNB, or a 5G New Radio (NR) gNB. The UE 130 may be implemented as mobile or fixed communication devices for accessing the wireless communication network 100. The one or more UE 130 may include but is not limited to mobile phones, internet of things (IoT) devices, machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1A, the one or more UE 130 may connect with and establish a communication session with the base station 122 via the OTA interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122. Under certain circumstances, for example when the base station 122 is unavailable or when the UE 130 moves into a coverage of the base station 124, the one or more UE 130 may connect with and establish a communication session with the base station 122.

Referring to FIG. 1B, a base station (e.g., gNB) 122 may have a control-distributed separated structure, which may include a control unit (CU) 160 and one or more distributed unit (DU) 171 and/or 172. The 5GC may communicate with the gNB via a NG interface between them. The gNB and another gNB may communicate via a Xn-C interface. The gNB-CU may communicate with the one or more gNB-DU via a F1 interface.

In some implementations, in the architecture of CU/DU split, a gNB may consist of a gNB Central Unit (gNB-CU) and one or more gNB Distributed Unit (gNB-DU). A gNB-CU and a gNB-DU is connected via F1 interface. The gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell is supported by only one gNB-DU.

In some implementations, the gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell may be supported by only one gNB-DU.

FIG. 1C shows another schematic diagram of a base station (e.g., gNB) 150. The gNB may have a control-distributed separated structure, which may include a control unit (CU) 160 and one or more distributed unit (DU) (for example 171 and/or 172). The CU may include a control plan (gNB-CU-CP) 161 and one or more user plan (gNB-CU-UP) 162. The gNB-CU-CP 161 may be referred as CU-CP or CP, and the gNB-CU-UP 162 may be referred as CU-UP or UP. The CU-CP 161 may communicate with the one or more CU-UP 162 via an E1 interface between them. The CU-CP 161 may communicate with the one or more DU via a F1-C interface, and each of the one or more CU-UP 162 may communicate with the one or more DU via a F1-U interface.

In some implementations, a gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP

In some implementations, for resiliency, a gNB-DU and/or a gNB-CU-UP may be connected to multiple gNB-CU-CPs by appropriate implementation. In some implementations, one gNB-DU can be connected to multiple gNB-CU-UPs under the control of the same gNB-CU-CP. In some implementations, one gNB-CU-UP can be connected to multiple DUs under the control of the same gNB-CU-CP.

In some implementations, the connectivity between a gNB-CU-UP and a gNB-DU is established by the gNB-CU-CP using bearer context management functions.

In some implementations, the gNB-CU-CP selects the appropriate gNB-CU-UP(s) for the requested services for the UE. In some implementations, multiple CU-UPs may belong to same security domain.

In some implementations, data forwarding between gNB-CU-UPs during intra-gNB-CU-CP handover within a gNB may be supported by Xn-U.

In various embodiments/implementations in the present disclosure, a protocol data unit (PDU) set may be a set including one or more PDUs carrying the payload of one unit of information generated at the application level (e.g. a frame or video slice). Data burst may include one or more PDU set generated and sent by the application in a short period of time. Periodicity may be the time duration between the start of two data bursts. Burst arrival time may be the latest possible time when the first packet of the data burst arrives at either the ingress of the RAN (downlink flow direction) or the egress interface of the UE (uplink flow direction).

In various embodiments/implementations in the present disclosure, a XR service may include video streaming, which is expressed by multiple application data units, and each application data unit is composed by multiple application frames (e.g. I-frame, P-frame, B-frame). Referring to FIG. 1D, one application frame may include at least one IP packets, which can be expressed in a PDU set (e.g. a sequence of packets that includes, e.g., all the necessary information to reconstruct a video frame, equivalent to the “media unit” or a “slice”, video/audio frame/tile, haptic application information) in QoS flow, e.g. GTP-U, NG user plane interface (NG-U), Xn User plane (Xn-U) interface, or user data from non-access stratum (NAS). For example, one of the application frames (I₁) may include a first PDU Set (PDU Set 1), which includes n PDUs (i.e., I₁₁, I₁₂, I₁₃, . . . . I₁ₙ), wherein n is a positive integer. For another example, another of the application frames (B₂) may include a second PDU Set (PDU Set 2), which includes m PDUs (i.e., B₁₁, B₁₂, B₁₃, . . . . B₁ₘ), wherein m is a positive integer.

In some implementations, an I-frame is a keyframe, which stores/transmits all of the data needed to display that frame. Typically, I-frames are interspersed with P-frames and B-frames in a compressed video. The more I-frames that are contained, the better quality the video will be; however, I-frames contain the most amount of bits and therefore take up more space on the storage medium and consumes more radio resource to deliver it over Uu interface. A P-frame is a delta frame, which contains only the data that have changed from the preceding I-frame (such as color or content changes). Because of this, P-frame depend on the preceding I-frame to fill in most of the data. A B-frame is also a delta frame, which contains only the data that have changed from the preceding frame and are different from the data in the very next frame. Thus, the B-frame depends on the frames preceding and following it to fill in most of the data.

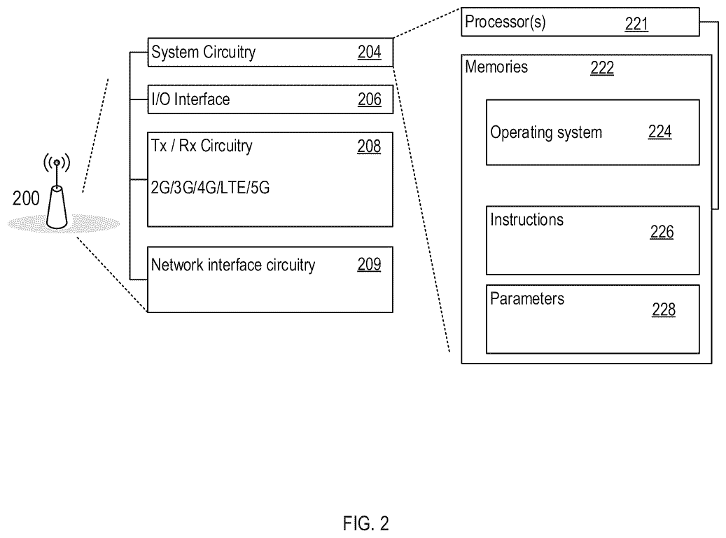

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

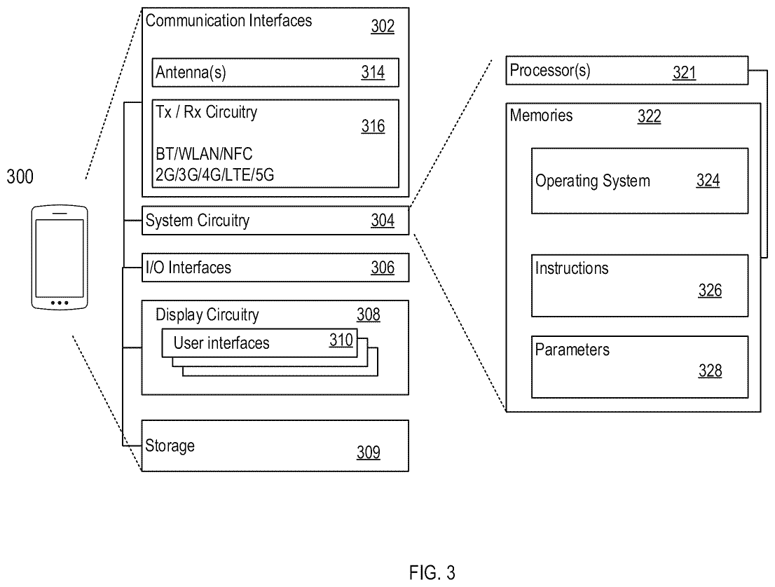

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for delivering quality of

service (QoS) flow information, which may be implemented, partly or totally, on the network base station and/or the user equipment described above in FIGS. 2-3.

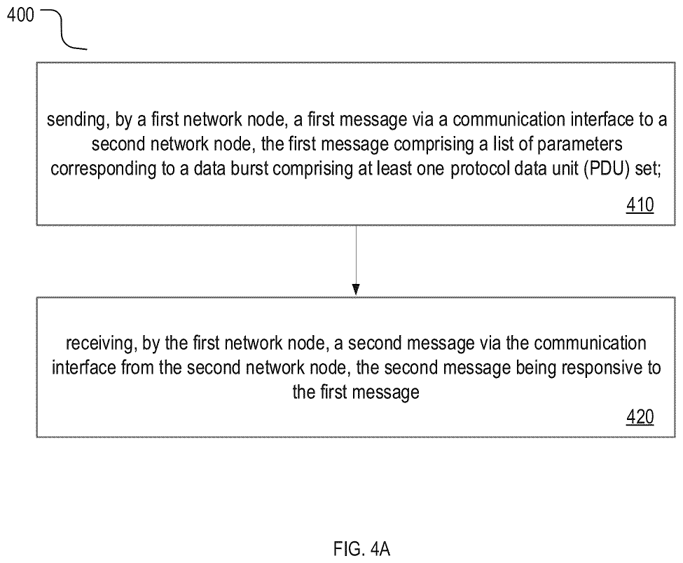

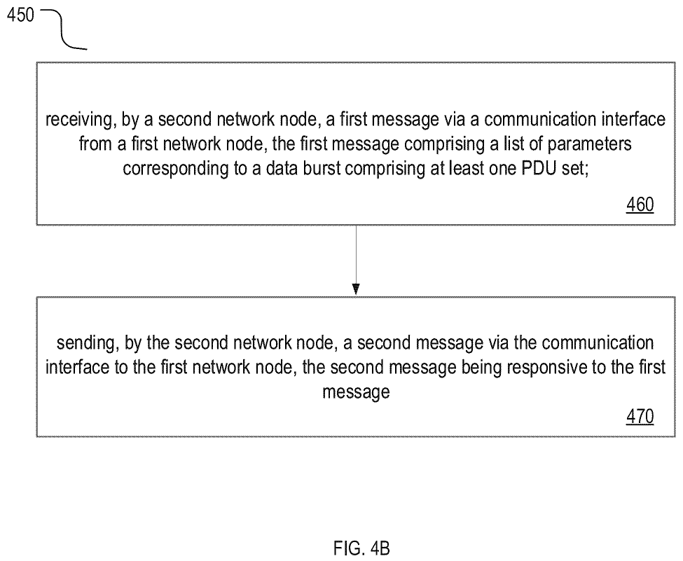

Referring to FIG. 4A, the present disclosure describes various embodiments of a method 400 for wireless communication. The method 400 may include a portion or all of the following steps: step 410, sending, by a first network node, a first message via a communication interface to a second network node, the first message comprising a list of parameters corresponding to a data burst comprising at least one protocol data unit (PDU) set; and/or step 420, receiving, by the first network node, a second message via the communication interface from the second network node, the second message being responsive to the first message.

Referring to FIG. 4B, the present disclosure describes various embodiments of a method 450 for wireless communication. The method 450 may include a portion or all of the following steps: step 460, receiving, by a second network node, a first message via a communication interface from a first network node, the first message comprising a list of parameters corresponding to a data burst comprising at least one PDU set; and/or step 470, sending, by the second network node, a second message via the communication interface to the first network node, the second message being responsive to the first message.

In some implementations, the list of parameters comprises at least one of the following: an uplink (UL) traffic periodicity, a downlink (DL) traffic periodicity, a UL traffic jitter information, a DL traffic jitter information (e.g. jitter range), a burst arrival time, or a list of PDU set quality of service (QoS) parameters; and/or the list of PDU set Qos parameters comprises at least one of the following: a PDU set error rate, a PDU set delay budget, or a PDU set integrated handling indication.

In some implementations, the first network node comprises an access and mobility management function (AMF) node; the second network node comprises a radio access network (RAN) node; and/or the communication interface comprises a NG interface.

In some implementations, the first message and the second message belong to NG interface messages.

In some implementations, the first message and the second message comprise one of the following: a PDU session resource setup request message and a PDU session resource setup response message, a PDU session resource modify request message and a PDU session resource modify response message, or a handover request message and a handover request acknowledge message; and/or the first message comprises at least one of the following information element (IE) that comprises the list of parameters: a time sensitive communication (TSC) traffic characteristics IE, a TSC assistance information IE, a QoS flow level QoS parameters IE, a QoS flow setup request list IE, or a QoS flow add or modify request list IE.

In some implementations, the first network node comprises a central unit (CU) of a RAN node; the second network node comprises a distributed unit (DU) of the RAN node; and/or the communication interface comprises a F1 interface.

In some implementations, the first message and the second message belong to F1 interface messages.

In some implementations, the first message and the second message respectively comprise one of the following: a user equipment (UE) context setup request message and a UE context setup request response message, or a UE context modification request message and a UE context modification request response message; and/or the first message comprises at least one of the following IEs that comprises the list of parameters: a TSC traffic characteristics IE, a TSC assistance information IE, a QoS flow level QoS parameters IE, a data radio bearer (DRB) to be setup list IE, or a DRB to be modified list IE.

In some implementations, the first network node comprises a control plane (CP) of a central unit (CU) of a RAN node; the second network node comprises a user plane (UP) of the CU of the RAN node; and/or the communication interface comprises a E1 interface.

In some implementations, the first message and the second message belong to E1 interface messages.

In some implementations, the first message and the second message respectively comprise one of the following: a bearer context setup request message and a bearer context setup request response message, or a bearer context modification request message and a bearer context modification request response message; and/or the first message comprises at least one of the following IEs that comprises the list of parameters: a TSC traffic characteristics IE, a TSC assistance information IE, a QoS flow level QoS parameters IE, a DRB to setup list IE, or a DRB to modify list IE.

In some implementations, the first network node comprises a source RAN node; the second network node comprises a target RAN node; and/or the communication interface comprises a Xn interface.

In some implementations, the first message and the second message respectively comprise a handover request message and a handover request acknowledge message; and/or the first message comprises at least one of the following IEs that comprises the list of parameters: a TSC traffic characteristics IE, a TSC assistance information IE, a QoS flow level QoS parameters IE, a PDU session resources to be setup list IE, a QoS flows to be setup list IE, a DRBs to be setup list IE, a QoS flows mapped to DRB list IE, a QoS flows to be modified list IE, or a DRBs to be modified list IE.

In some implementations, the first network node comprises a new RAN node; the second network node comprises an old RAN node; and/or the communication interface comprises a Xn interface.

In some implementations, the first message and the second message respectively comprise a retrieve UE context request message and a retrieve UE context response message; and/or the first message comprises at least one of the following IEs that comprises the list of parameters: a TSC traffic characteristics IE, a TSC assistance information IE, a QoS flow level QoS parameters IE, a PDU session resources to be setup list IE, a QoS flows to be setup list IE, a DRBs to be setup list IE, a QoS flows mapped to DRB list IE, a QoS flows to be modified list IE, or a DRBs to be modified list IE.

In some implementations, the first network node comprises a master node (MN); the second network node comprises a secondary node (SN); and/or the communication interface comprises a Xn interface.

In some implementations, the first message and the second message respectively comprise one of the following: a S-node addition request message and a S-node addition request acknowledge message, or a S-node modification request message and a S-node modification request acknowledge message; and/or the first message comprises at least one of the following IEs that comprises the list of parameters: a TSC traffic characteristics IE, a TSC assistance information IE, a QoS flow level QoS parameters IE, a PDU session resources to be setup list IE, a QoS flows to be setup list IE, a DRBs to be setup list IE, a QoS flows mapped to DRB list IE, a QoS flows to be modified list IE, or a DRBs to be modified list IE.

The present disclosure describes various embodiments with exemplary examples for delivering quality of service (QoS) flow information. Exemplary embodiments provide examples for the present disclosure, and does not impose any limitation on the present disclosure. In the embodiments and implementation of this disclosure, any steps and/or operations may be combined or arranged in any amount or order, as desired. Two or more of the steps and/or operations may be performed in parallel. Embodiments and implementations in the disclosure may be used separately or combined in any order. Further, any one of the methods (or embodiments), a wireless communication node, and a wireless communication device may be implemented by processing circuitry (e.g., one or more processors or one or more integrated circuits).

### Embodiment Set I

### QoS Flow Information Delivered via NG Interface

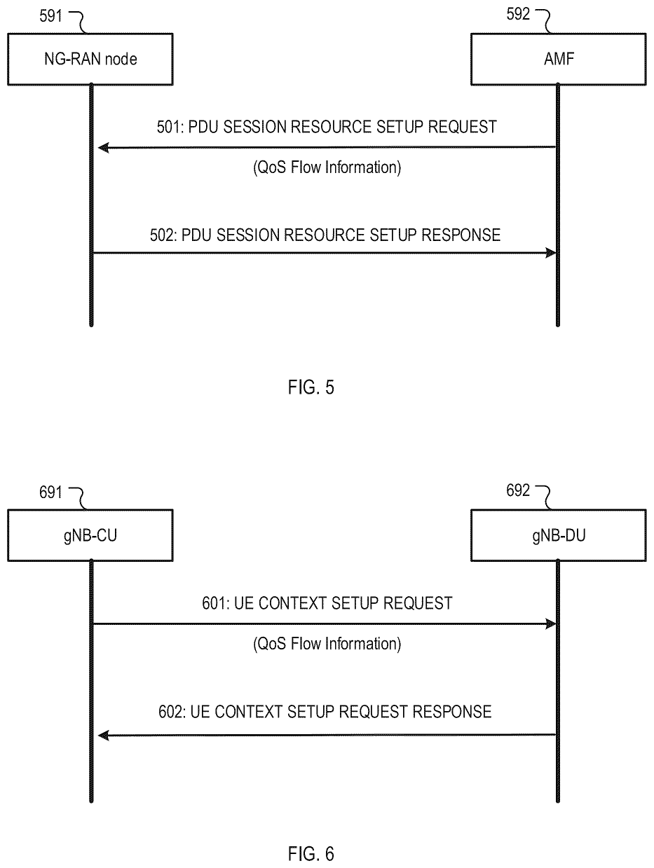

Various embodiments in the present disclosure describe QoS flow information being delivered via NG interface. FIG. 5 shows a non-limiting example between a NG-RAN node 591 and an AMF 592.

For step 501: The AMF sends the QoS flow information via a NG interface message (e.g. PDU SESSION RESOURCE SETUP REQUEST message, PDU SESSION RESOURCE MODIFY REQUEST message, or HANDOVER REQUEST message) to the NG-RAN node.

The QoS flow information may include a portion or all of the following: the UL traffic periodicity, DL traffic periodicity, UL traffic jitter information (e.g. jitter range), DL traffic jitter information (e.g. jitter range), burst arrival time, PDU set QoS parameters of the QoS flow. In some implementations, the PDU set QoS parameter of the QoS flow may be applicable to all PDU sets of the QoS flow, and may include a portion or all of the following: the PDU set error rate, PDU set delay budget, PDU set integrated handling indication. The QoS flow information is used to optimize gNB radio resource scheduling, e.g. improving scheduling efficiency. This can also be used for QoS flow to DRB mapping.

In some implementations, the PDU set integrated handling indication is used to indicate whether all PDUs of the PDU set are needed for the usage of PDU set by an application layer, for example, under certain conditions when one or more PDU has transmission error.

In some implementations, the UL traffic periodicity indicates a periodicity for UL traffic of the QoS Flow, indicating whether UL traffic is periodic and/or what the period of the UL traffic may be.

In some implementations, the DL traffic periodicity indicates a periodicity for DL traffic of the QoS Flow, indicating whether DL traffic is periodic and/or what the period of the DL traffic may be.

In some implementations, the DL traffic jitter information may indicate a jitter range, which may be associated with each periodicity of the QoS flow, and may indicate a time duration of the jitter range.

In some implementations, the UL traffic jitter information may indicate a jitter range, which may be associated with each periodicity of the QoS flow, and may indicate a time duration of the jitter range.

In some implementations, PDU set error rate (PSER) may define an upper bound for a non-congestion related PDU set loss rate between RAN and UE. In some implementations, the PSER may correspond to the PDU sets that have been processed by a transmitting device (for example, RAN), but are not delivered by a receiving device (for example, UE).

In some implementations, in DL, PDU set delay budget may indicate a time and/or duration between reception of the first PDU at the UPF and the successful delivery of the last arrived PDU of a PDU set at the UE. In some implementations, in UL, PDU set delay budget may indicate a time and/or duration between reception of the first PDU at the UE and the successful delivery of the last arrived PDU of a PDU set at the UPF.

In some implementations, the QoS flow information may be defined as a new information element (IE) or included in an existing IE such as Time Sensitive Communication (TSC) Traffic Characteristics IE or TSC Assistance Information IE or QoS Flow Level QoS Parameters IE or QoS Flow Setup Request List IE or QoS Flow Add or Modify Request List IE.

For step 502: The NG-RAN node responds with a NG interface message (e.g. PDU SESSION RESOURCE SETUP RESPONSE message, PDU SESSION RESOURCE MODIFY RESPONSE message, or HANDOVER REQUEST ACKNOWLEDGE message).

### Embodiment Set II

### QoS Flow Information Delivered via F1 Interface

Various embodiments in the present disclosure describe QoS flow information being delivered via F1 interface. FIG. 6 shows a non-limiting example between a gNB-CU 691 and a gNB-DU 692.

For step 601: The gNB-CU sends the QoS flow information via F1 interface message (e.g. UE CONTEXT SETUP REQUEST message, or UE CONTEXT MODIFICATION REQUEST message) to the gNB-DU.

In some implementations, the QoS flow information may include a portion or all of the following: the UL traffic periodicity, DL traffic periodicity, UL traffic jitter information (e.g. jitter range), DL traffic jitter information (e.g. jitter range), burst arrival time, PDU set QoS parameters of the QoS flow. The PDU set QoS parameter of the QoS flow may be applicable to all PDU sets of the QoS flow, and may include a portion or all of the following: the PDU set error rate, PDU set delay budget, PDU set integrated handling indication. In some implementations, the QoS flow information is used to optimize gNB radio resource scheduling, e.g. improving scheduling efficiency. This can also be used for QoS flow to DRB mapping.

In some implementations, the PDU set integrated handling indication is used to indicate whether all PDUs of the PDU set are needed for the usage of PDU set by an application layer, for example, under certain conditions when one or more PDU has transmission error.

In some implementations, the UL traffic periodicity indicates a periodicity for UL traffic of the QoS Flow, indicating whether UL traffic is periodic and/or what the period of the UL traffic may be.

In some implementations, the DL traffic periodicity indicates a periodicity for DL traffic of the QoS Flow, indicating whether DL traffic is periodic and/or what the period of the DL traffic may be.

In some implementations, the DL traffic jitter information may indicate a jitter range, which may be associated with each periodicity of the QoS flow, and may indicate a time duration of the jitter range.

In some implementations, the UL traffic jitter information may indicate a jitter range, which may be associated with each periodicity of the QoS flow, and may indicate a time duration of the jitter range.

In some implementations, PDU set error rate (PSER) may define an upper bound for a non-congestion related PDU set loss rate between RAN and UE. In some implementations, the PSER may correspond to the PDU sets that have been processed by a transmitting device (for example, RAN), but are not delivered by a receiving device (for example, UE) to its upper layer.

In some implementations, in DL, PDU set delay budget may indicate a time and/or duration between reception of the first PDU at the UPF and the successful delivery of the last arrived PDU of a PDU set at the UE. In some implementations, in UL, PDU set delay budget may indicate a time and/or duration between reception of the first PDU at the UE and the successful delivery of the last arrived PDU of a PDU set at the UPF.

In some implementations, the QoS flow information can be defined as a new information element (IE) or included in an existing IE such as Time Sensitive Communication (TSC) Traffic Characteristics IE or TSC Assistance Information IE or QoS Flow Level QoS Parameters IE or DRB to Be Setup List IE or DRB to Be Modified List IE.

For step 602: The gNB-DU responds with F1 interface message (e.g. UE CONTEXT MODIFICATION REQUEST RESPONSE message, or UE CONTEXT MODIFICATION REQUEST RESPONSE message).

### Embodiment Set III

### QoS Flow Information Delivered via E1 Interface

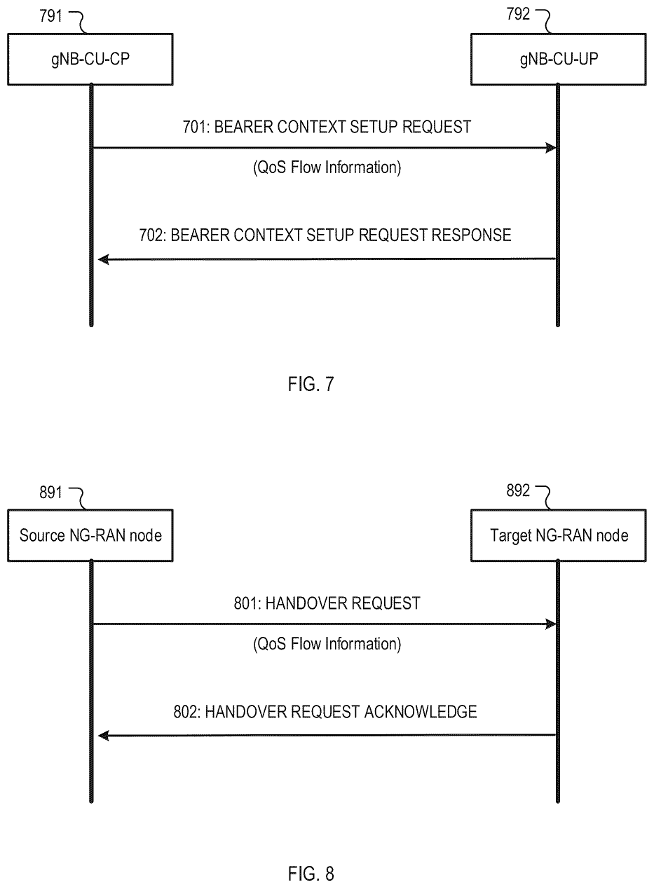

Various embodiments in the present disclosure describe QoS flow information being delivered via E1 interface. FIG. 7 shows a non-limiting example between a gNB-CU-CP 791 and a gNB-DU-UP 792.

For step 701: The gNB-CU-CP sends the QoS flow information via E1 interface message (e.g. BEARER CONTEXT SETUP REQUEST message, or BEARER CONTEXT MODIFICATION REQUEST message) to the gNB-CU-UP.

In some implementations, the QoS flow information may include a portion or all of the following: the UL traffic periodicity, DL traffic periodicity, UL traffic jitter information (e.g. jitter range), DL traffic jitter information (e.g. jitter range), burst arrival time, PDU set QoS parameters of the QoS flow. The PDU set QoS parameter of the QoS flow may be applicable to all PDU sets of the QoS flow, and may include a portion or all of the following: the PDU set error rate, PDU set delay budget, PDU set integrated handling indication. In some implementations, the QoS flow information is used to optimize gNB radio resource scheduling, e.g. improving scheduling efficiency. This can also be used for QoS flow to DRB mapping.

In some implementations, the PDU set integrated handling indication is used to indicate whether all PDUs of the PDU set are needed for the usage of PDU set by an application layer, for example, under certain conditions when one or more PDU has transmission error.

In some implementations, the UL traffic periodicity indicates a periodicity for UL traffic of the QoS Flow, indicating whether UL traffic is periodic and/or what the period of the UL traffic may be.

In some implementations, the DL traffic periodicity indicates a periodicity for DL traffic of the QoS Flow, indicating whether DL traffic is periodic and/or what the period of the DL traffic may be.

In some implementations, the DL traffic jitter information may indicate a jitter range, which may be associated with each periodicity of the QoS flow, and may indicate a time duration of the jitter range.

In some implementations, the UL traffic jitter information may indicate a jitter range, which may be associated with each periodicity of the QoS flow, and may indicate a time duration of the jitter range.

In some implementations, PDU set error rate (PSER) may define an upper bound for a non-congestion related PDU set loss rate between RAN and UE. In some implementations, the PSER may correspond to the PDU sets that have been processed by a transmitting device (for example, RAN), but are not delivered by a receiving device (for example, UE) to its upper layer.

In some implementations, in DL, PDU set delay budget may indicate a time and/or duration between reception of the first PDU at the UPF and the successful delivery of the last arrived PDU of a PDU set at the UE. In some implementations, in UL, PDU set delay budget may indicate a time and/or duration between reception of the first PDU at the UE and the successful delivery of the last arrived PDU of a PDU set at the UPF.

In some implementations, the QoS flow information can be defined as a new information element (IE) or included in an existing IE such as Time Sensitive Communication (TSC) Traffic Characteristics IE or TSC Assistance Information IE or QoS Flow Level QoS Parameters IE or DRB To Setup List IE or DRB To Modify List IE.

For step 702: The gNB-CU-UP responds with E1 interface message (e.g. BEARER CONTEXT SETUP RESPONSE message, or BEARER CONTEXT MODIFICATION RESPONSE message).

### Embodiment Set IV

### QoS Flow Information Delivered via Xn Interface for Handover

Various embodiments in the present disclosure describe QoS flow information being delivered via Xn interface for handover. FIG. 8 shows a non-limiting example between a gNB-CU-CP 891 and a gNB-DU-UP 892.

For step 801: The source NG-RAN node sends the QoS flow information via Xn interface message (e.g. HANDOVER REQUEST message) to the target NG-RAN node.

In some implementations, the QoS flow information may include a portion or all of the following: the UL traffic periodicity, DL traffic periodicity, UL traffic jitter information (e.g. jitter range), DL traffic jitter information (e.g. jitter range), burst arrival time, PDU set QoS parameters of the QoS flow. The PDU set QoS parameter of the QoS flow may be applicable to all PDU sets of the QoS flow, and may include a portion or all of the following: the PDU set error rate, PDU set delay budget, PDU set integrated handling indication. In some implementations, the QoS flow information is used to optimize gNB radio resource scheduling, e.g. improving scheduling efficiency. This can also be used for QoS flow to DRB mapping.

In some implementations, the PDU set integrated handling indication is used to indicate whether all PDUs of the PDU set are needed for the usage of PDU set by an application layer, for example, under certain conditions when one or more PDU has transmission error.

In some implementations, the UL traffic periodicity indicates a periodicity for UL traffic of the QoS Flow, indicating whether UL traffic is periodic and/or what the period of the UL traffic may be.

In some implementations, the DL traffic periodicity indicates a periodicity for DL traffic of the QoS Flow, indicating whether DL traffic is periodic and/or what the period of the DL traffic may be.

In some implementations, the DL traffic jitter information may indicate a jitter range, which may be associated with each periodicity of the QoS flow, and may indicate a time duration of the jitter range.

In some implementations, the UL traffic jitter information may indicate a jitter range, which may be associated with each periodicity of the QoS flow, and may indicate a time duration of the jitter range.

In some implementations, PDU set error rate (PSER) may define an upper bound for a non-congestion related PDU set loss rate between RAN and UE. In some implementations, the PSER may correspond to the PDU sets that have been processed by a transmitting device (for example, RAN), but are not delivered by a receiving device (for example, UE) to its upper layer.

In some implementations, in DL, PDU set delay budget may indicate a time and/or duration between reception of the first PDU at the UPF and the successful delivery of the last arrived PDU of a PDU set at the UE. In some implementations, in UL, PDU set delay budget may indicate a time and/or duration between reception of the first PDU at the UE and the successful delivery of the last arrived PDU of a PDU set at the UPF.

In some implementations, the QoS flow information can be defined as a new information element (IE) or included in an existing IE such as Time Sensitive Communication (TSC) Traffic Characteristics IE or TSC Assistance Information IE or QoS Flow Level QoS Parameters IE or PDU Session Resources To Be Setup List IE or QoS Flows To Be Setup List IE or DRBs To Be Setup List IE or QoS Flows Mapped To DRB List IE or QoS Flows To Be Modified List IE or DRBs To Be Modified List IE.

For step 802: The target NG-RAN node responds with Xn interface message (e.g. HANDOVER REQUEST ACKNOWLEDGE message).

### Embodiment Set V

### QoS Flow Information Delivered via Xn Interface to Retrieve UE Context

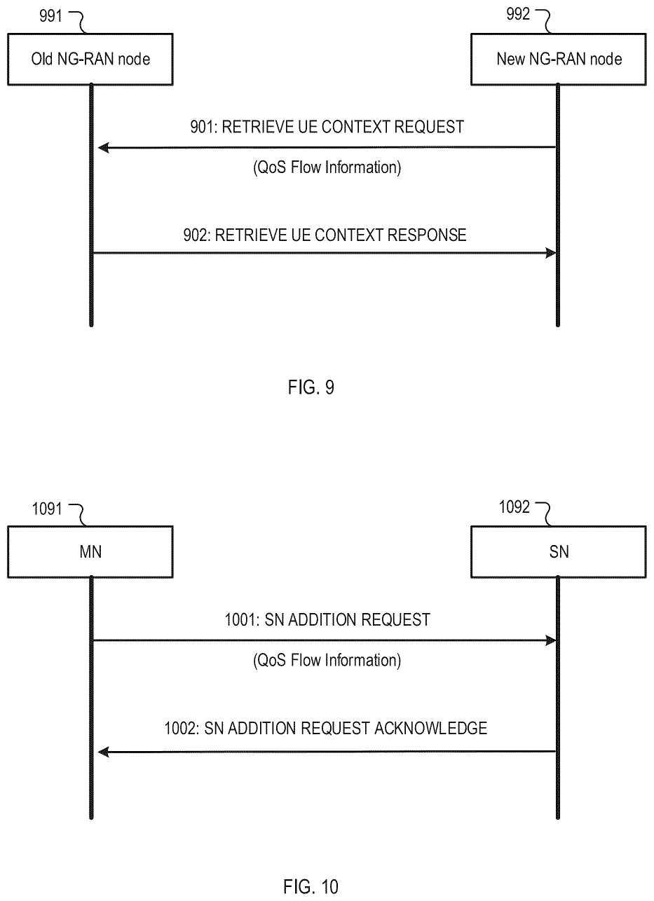

Various embodiments in the present disclosure describe QoS flow information being delivered via Xn interface to retrieve UE context. FIG. 9 shows a non-limiting example between an old NG-RAN node 991 and a new NG-RAN node 992.

For step 901: The new NG-RAN node sends Xn interface message to retrieve UE context (e.g. RETRIEVE UE CONTEXT REQUEST message).

For step 902: The old NG-RAN node responds with the QoS flow information via Xn interface message (e.g. RETRIEVE UE CONTEXT RESPONSE message) to the new NG-RAN node.

In some implementations, the QoS flow information may include a portion or all of the following: the UL traffic periodicity, DL traffic periodicity, UL traffic jitter information (e.g. jitter range), DL traffic jitter information (e.g. jitter range), burst arrival time, PDU set QoS parameters of the QoS flow. The PDU set QoS parameter of the QoS flow may be applicable to all PDU sets of the QoS flow, and may include a portion or all of the following: the PDU set error rate, PDU set delay budget, PDU set integrated handling indication. In some implementations, the QoS flow information is used to optimize gNB radio resource scheduling, e.g. improving scheduling efficiency. This can also be used for QoS flow to DRB mapping.

In some implementations, the PDU set integrated handling indication is used to indicate whether all PDUs of the PDU set are needed for the usage of PDU set by an application layer, for example, under certain conditions when one or more PDU has transmission error.

In some implementations, the UL traffic periodicity indicates a periodicity for UL traffic of the QoS Flow, indicating whether UL traffic is periodic and/or what the period of the UL traffic may be.

In some implementations, the DL traffic periodicity indicates a periodicity for DL traffic of the QoS Flow, indicating whether DL traffic is periodic and/or what the period of the DL traffic may be.

In some implementations, the DL traffic jitter information may indicate a jitter range, which may be associated with each periodicity of the QoS flow, and may indicate a time duration of the jitter range.

In some implementations, the UL traffic jitter information may indicate a jitter range, which may be associated with each periodicity of the QoS flow, and may indicate a time duration of the jitter range.

In some implementations, PDU set error rate (PSER) may define an upper bound for a non-congestion related PDU set loss rate between RAN and UE. In some implementations, the PSER may correspond to the PDU sets that have been processed by a transmitting device (for example, RAN), but are not delivered by a receiving device (for example, UE) to its upper layer.

In some implementations, in DL, PDU set delay budget may indicate a time and/or duration between reception of the first PDU at the UPF and the successful delivery of the last arrived PDU of a PDU set at the UE. In some implementations, in UL, PDU set delay budget may indicate a time and/or duration between reception of the first PDU at the UE and the successful delivery of the last arrived PDU of a PDU set at the UPF.

In some implementations, the QoS flow information can be defined as a new information element (IE) or included in an existing IE such as Time Sensitive Flow Level QoS Parameters IE or PDU Session Resources To Be Setup List IE or QoS

Flows To Be Setup List IE or DRBs To Be Setup List IE or QoS Flows Mapped To DRB List IE or QoS Flows To Be Modified List IE or DRBs To Be Modified List IE.

### Embodiment Set VI

### QoS Flow Information Delivered via Xn Interface for MR-DC

Various embodiments in the present disclosure describe QoS flow information being delivered via Xn interface for multi-radio dual connectivity (MR-DC). FIG. 10 shows a non-limiting example between a master node (MN) 1091 and a secondary node (SN) 1092.

For step 1001: The MN sends the QoS flow information via Xn interface message (e.g. S-NODE ADDITION REQUEST message, S-NODE MODIFICATION REQUEST message) to the SN.

In some implementations, the QoS flow information may include a portion or all of the following: the UL traffic periodicity, DL traffic periodicity, UL traffic jitter information (e.g. jitter range), DL traffic jitter information (e.g. jitter range), burst arrival time, PDU set QoS parameters of the QoS flow. The PDU set QoS parameter of the QoS flow may be applicable to all PDU sets of the QoS flow, and may include a portion or all of the following: the PDU set error rate, PDU set delay budget, PDU set integrated handling indication. In some implementations, the QoS flow information is used to optimize gNB radio resource scheduling, e.g. improving scheduling efficiency. This can also be used for QoS flow to DRB mapping.

In some implementations, the PDU set integrated handling indication is used to indicate whether all PDUs of the PDU set are needed for the usage of PDU set by an application layer, for example, under certain conditions when one or more PDU has transmission error.

In some implementations, the UL traffic periodicity indicates a periodicity for UL traffic of the QoS Flow, indicating whether UL traffic is periodic and/or what the period of the UL traffic may be.

In some implementations, the DL traffic periodicity indicates a periodicity for DL traffic of the QoS Flow, indicating whether DL traffic is periodic and/or what the period of the DL traffic may be.

In some implementations, the DL traffic jitter information may indicate a jitter range, which may be associated with each periodicity of the QoS flow, and may indicate a time duration of the jitter range.

In some implementations, the UL traffic jitter information may indicate a jitter range, which may be associated with each periodicity of the QoS flow, and may indicate a time duration of the jitter range.

In some implementations, PDU set error rate (PSER) may define an upper bound for a non-congestion related PDU set loss rate between RAN and UE. In some implementations, the PSER may correspond to the PDU sets that have been processed by a transmitting device (for example, RAN), but are not delivered by a receiving device (for example, UE) to its upper layer.

In some implementations, in DL, PDU set delay budget may indicate a time and/or duration between reception of the first PDU at the UPF and the successful delivery of the last arrived PDU of a PDU set at the UE. In some implementations, in UL, PDU set delay budget may indicate a time and/or duration between reception of the first PDU at the UE and the successful delivery of the last arrived PDU of a PDU set at the UPF.

In some implementations, the QoS flow information can be defined as a new information element (IE) or included in an existing IE such as Time Sensitive Communication (TSC) Traffic Characteristics IE or TSC Assistance Information IE or QoS Flow Level QoS Parameters IE or PDU Session Resources To Be Setup List IE or QoS Flows To Be Setup List IE or DRBs To Be Setup List IE or QoS Flows Mapped To DRB List IE or QoS Flows To Be Modified List IE or DRBs To Be Modified List IE.

For step 1002: The SN responds with Xn interface message (e.g. S-NODE MODIFICATION REQUEST ACKNOWLEDGE message, or S-NODE MODIFICATION REQUEST ACKNOWLEDGE message).

The present disclosure describes methods, apparatus, and computer-readable medium for wireless communication. The present disclosure addressed the issues with delivering quality of service (QoS) flow information. The methods, devices, and computer-readable medium described in the present disclosure may facilitate the performance of wireless communication by delivering QoS flow information, thus improving efficiency and overall performance. The methods, devices, and computer-readable medium described in the present disclosure may improve the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
sending, by a first network node, a first message via a communication interface to a second network node, the first message comprising a list of parameters corresponding to a data burst comprising at least one protocol data unit (PDU) set; and
receiving, by the first network node, a second message via the communication interface from the second network node, the second message being responsive to the first message.

2. A method for wireless communication, comprising:
receiving, by a second network node, a first message via a communication interface from a first network node, the first message comprising a list of parameters corresponding to a data burst comprising at least one PDU set; and
sending, by the second network node, a second message via the communication interface to the first network node, the second message being responsive to the first message.

3. The method according to claim 1, wherein:
the list of parameters comprises at least one of the following: a DL traffic jitter information, or a list of PDU set quality of service (QoS) parameters; and
the list of PDU set QoS parameters comprises at least one of the following: a PDU set error rate, a PDU set delay budget, or a PDU set integrated handling indication.

4. The method according to claim 1, wherein:
the first network node comprises an access and mobility management function (AMF) node;
the second network node comprises a radio access network (RAN) node; and
the communication interface comprises a NG interface.

5. The method according to claim 4, wherein:
the first message and the second message belong to NG interface messages.

6. The method according to claim 4, wherein:
the first message and the second message comprise one of the following: a PDU session resource setup request message and a PDU session resource setup response message, a PDU session resource modify request message and a PDU session resource modify response message, or a handover request message and a handover request acknowledge message.

7. The method according to claim 1, wherein:
the first network node comprises a central unit (CU) of a RAN node;
the second network node comprises a distributed unit (DU) of the RAN node; and
the communication interface comprises a F1 interface.

8. The method according to claim 7, wherein:
the first message and the second message belong to F1 interface messages.

9. The method according to claim 7, wherein:
the first message and the second message respectively comprise one of the following: a user equipment (UE) context setup request message and a UE context setup request response message, or a UE context modification request message and a UE context modification request response message; and
the first message comprises at least one of the following IEs that comprises the list of parameters: a TSC traffic characteristics IE, or a QoS flow level QoS parameters IE.

10. The method according to claim 1, wherein:
the first network node comprises a control plane (CP) of a central unit (CU) of a RAN node;
the second network node comprises a user plane (UP) of the CU of the RAN node; and
the communication interface comprises a E1 interface.

11. The method according to claim 10, wherein:
the first message and the second message belong to E1 interface messages.

12. The method according to claim 10, wherein:
the first message and the second message respectively comprise one of the following: a bearer context setup request message and a bearer context setup request response message, or a bearer context modification request message and a bearer context modification request response message; and
the first message comprises at least one of the following IEs that comprises the list of parameters: a TSC traffic characteristics IE, or a QoS flow level QoS parameters IE.

13. The method according to claim 1, wherein:
the first network node comprises a source RAN node;
the second network node comprises a target RAN node; and
the communication interface comprises a Xn interface.

14. The method according to claim 13, wherein:
the first message and the second message respectively comprise a handover request message and a handover request acknowledge message; and
the first message comprises at least one of the following IEs that comprises the list of parameters: a TSC traffic characteristics IE, or a QoS flow level QoS parameters IE.

15-21. (canceled)

22. The method according to claim 2, wherein:
the list of parameters comprises at least one of the following: a DL traffic jitter information, or a list of PDU set quality of service (QoS) parameters; and
the list of PDU set QoS parameters comprises at least one of the following: a PDU set error rate, a PDU set delay budget, or a PDU set integrated handling indication.

23. The method according to claim 2, wherein:
the first network node comprises an access and mobility management function (AMF) node;
the second network node comprises a radio access network (RAN) node;
the communication interface comprises a NG interface; and
the first message and the second message belong to NG interface messages.

24. The method according to claim 2, wherein:
the first network node comprises a central unit (CU) of a RAN node;
the second network node comprises a distributed unit (DU) of the RAN node;
the communication interface comprises a F1 interface; and
the first message and the second message belong to F1 interface messages.

25. The method according to claim 2, wherein:
the first network node comprises a control plane (CP) of a central unit (CU) of a RAN node;
the second network node comprises a user plane (UP) of the CU of the RAN node;
the communication interface comprises a E1 interface; and
the first message and the second message belong to E1 interface messages.

26. An apparatus comprising:
a memory storing instructions; and
at least one processor in communication with the memory, wherein, when the at least one processor executes the instructions, the at least one processor is configured to cause the apparatus to perform:
sending a first message via a communication interface to a network node, the first message comprising a list of parameters corresponding to a data burst comprising at least one protocol data unit (PDU) set; and
receiving a second message via the communication interface from the network node, the second message being responsive to the first message.

27. An apparatus comprising:
a memory storing instructions; and
at least one processor in communication with the memory, wherein, when the at least one processor executes the instructions, the at least one processor is configured to cause the apparatus to perform:
receiving a first message via a communication interface from a network node, the first message comprising a list of parameters corresponding to a data burst comprising at least one PDU set; and
sending a second message via the communication interface to the network node, the second message being responsive to the first message.
